(19) United States
(12) Patent Application Publication
(10) Pub. No.: US 2011/0070392 A1
(43) Pub. Date: Mar. 24, 2011

(54) Item for covering surfaces

(75) Inventor: Corrado Ferfoglia, Fiorano Modenese (IT)

(73) Assignee: FLORIM CERAMICHE S.P.A., Fiorano Modenese (IT)

(21) Appl. No.: 12/887,765

(22) Filed: Sep. 22, 2010

(30) Foreign Application Priority Data
Sep. 23, 2009 (IT) MO2009A000236

(51) Int. Cl. B32B 3/14; B32B 37/00

(52) U.S. Cl. 428/55; 156/297

(57) ABSTRACT

An item for covering surfaces includes a body having a polygonal perimeter, which is defined by a visible face configured to face outwards and by an opposite laying face. Said body includes a bearing core made of a first material having a first specific weight, and a plurality of covering elements made of a second material having a second specific weight and fixed to at least the visible face according to a preselected pattern, the first specific weight being lower than the second specific weight.

### FIELD OF THE INVENTION

The present invention relates to an item for covering surfaces, particularly adapted for quickly and inexpensively covering swimming pool edges. The weight of the item, for a given size, is smaller than that of the ceramic or stone products that are typically used for covering surfaces in general and particularly swimming pool edges.

### BACKGROUND ART

Ceramic items for covering surfaces have been long available that consist of a substantially compact body formed of one piece, by a pressing process, or by extrusion and final firing, in kilns designed for this purpose.

Particularly in the field of swimming pools, the need exists of using ceramic items for covering both the walkable areas surrounding the water-containing pool, and the pool itself with its drains.

The surface area and profile of these items must be designed to ensure sufficient grip under wet feet even in the presence of water, to avoid slip and fall accidents.

An area that is particularly exposed to this risk is a swimming pool edge, which forms the boundary between the water surface and the walkable surface around the pool, and acts as a support and walking surface for bathers that get into or out of water.

Therefore, a swimming pool edge should ensure the highest safety in terms of prevention of slip and fall accidents and should have, as mentioned above, a surface designed to provide the best grip under the feet, even wet feet, while providing a safe handhold for the bathers, when they need it, for instance when they want to come out of the water or get into it, without using the ladders that are typically provided for this purpose.

Swimming pool edges should also act as a small dam all around the pool to prevent water splashed out by movements by bathers from overflowing to the surrounding walkable area.

For these reasons, the ceramic items that are currently used to cover swimming pools, and particularly swimming pool edges, are typically in the form of square or rectangular tiles and in both cases their thickness changes from zone to zone.

Namely, the side designed to become a section of the pool edge when laid next to other items, typically has an enlarged and rounded profile with respect to the rest of that item, which is substantially flat and thin, thereby forming, with other sections of other adjacent items, a sort of projecting handrail all around the pool, having a toroidal or substantially toroidal shape, and adapted to be grasped, and to further act as a small dam for preventing or at least limiting water overflow.

Nevertheless, these prior art items suffer from certain drawbacks.

A first drawback is that, due to their one-piece conformation, the prior art items involve manufacturing problems associated with their varying thickness, because, if they are formed by a pressing process, these thickness variations require compression forces differently arranged through the various areas of the ceramic material loaded in the press molds.

Therefore, the items are pressed in different manners from zone to zone.

This will cause abnormal shrinkage during the firing step in the kiln, due to evaporation of the moisture within the materials, which will eventually provide items of irregular shapes, i.e. imperfect items.

The same abnormal shrinkage effect occurs when the items are formed by extruding a pasty ceramic strip to be later cut to size and fired.

Another drawback is that the ceramic items that are used for covering surfaces, and particularly swimming pool edges, have a considerable weight, because they are formed as individual pieces, and must be very strongly fixed to the surfaces on which they are laid, e.g. the faces of the concrete structure that forms the pool and its edges.

The lying face of the items also requires a waterproofing treatment to avoid water and moisture infiltrations, and prevent the items from separating from the surfaces on which they are laid and fixed.

This requires the use of considerable amounts of adhesive materials and waterproofing materials, which increases the overall costs.

A further drawback is that, in order to cover swimming pool edges having irregular perimeters, composed of rectilinear and rounded sections, special items must be formed, having shapes adapted to cover these perimeters in a substantially seamless manner between each item and those next to it.

The fabrication of these items, that are known in the art as “special parts,” requires additional processing after normal manufacture, e.g. special cutting of finished products having a regular perimeter.

Therefore, the manufacture of these special parts is very expensive and causes additional cost increases.

### SUMMARY OF THE INVENTION

One object of the present invention is to improve the state of the art.

Another object is to provide an item for covering surfaces that has a light weight and a low cost, and can cover any surface, particularly swimming pool edges, even when these have irregular perimeters, and that maintains the same safety and strength characteristics as a conventional item.

In one aspect, the invention relates to an item for covering surfaces comprising a body that has a polygonal perimeter and defines a visible face designed to face outwards and an opposite lying face, characterized in that said body comprises a bearing core made of a first material having a first specific weight, and a plurality of covering elements made of a second material having a second specific weight and fixed to at least said visible face according to a preselected pattern, said first specific weight being lower than said second specific weight.

Therefore, the invention affords the following advantages:

providing an item for covering surfaces that is considerably lighter than prior art items;

covering surfaces having linear, curvilinear, or mixtilinear outlines;

providing the swimming pools with edges that ensure safe handhold for bathers and limit water overflow;

providing an item that has an exposed face formed as needed;

easily forming the items with regular or irregular shapes;

providing covers for surfaces that have a heat insulating effect.

### BRIEF DESCRIPTION OF THE DRAWINGS

Additional features and advantages of the invention will become more apparent upon reading the detailed description of a preferred, non exclusive embodiment of an item for covering surfaces, which is described as a non limiting example with the support of the accompanying drawings, in which:

FIG. 1 is a schematic longitudinal cross-sectional view of an item for covering surfaces according to the invention, laid on a swimming pool edge;

FIG. 2 is a schematic longitudinal cross-sectional view of the item of FIG. 1, with certain parts exploded; and

FIG. 3 is a cross-sectional view of an item for covering surfaces according to the invention during a manufacturing step.

### DETAILED DESCRIPTION OF A PREFERRED EMBODIMENT

Referring to the above figures, numeral 1 generally designates an item for covering surfaces, particularly swimming pool edges 2, which will be briefly referred to hereinafter as item 1.

As can be seen, the item 1 comprises a core 3 made of a plastic material, typically a thermoplastic polymer, such as polystyrene, which is shaped into a predetermined shape, and comprises a substantially flat laying face 4, designed to face toward a surface 5 to be covered, and an opposite and parallel visible face 6, which is designed to face outwards and is also substantially flat.

Core 3, which is quadrangular in this case, also defines at least one side 7, which is designed to be placed parallel to the swimming pool edge 2 to be covered to act as a graspable handrail, and has, for this purpose, an enlarged portion 8 on its frontal side that has, in this case, a convex and rounded profile, but may also have a concave profile. The latter embodiment is not shown in detail in the drawings because the skilled person can evince it from the convex-profile embodiment of the figure.

As it can be seen, cover elements 9 are placed on the visible face of the core 3 and on the side 7 with the enlarged portion 8, which elements are in the form of strips 10, which may be made, for example but but without limitation of a ceramic material, a stone material, a wood material, a plastic material or by-products thereof

Cover elements 9 may have different shapes and sizes of strips 10, which may be, for instance, mosaic tiles.

Therefore, item 1 is generally formed by joining together elements made of at least two different materials, with different specific weights, so that the core 3 is caused to be considerably lighter than cover elements 9.

Core 3 may also have other shapes, because polystyrene allows easy processing and shaping in response to various needs, e.g. to obtain items with irregular perimeters.

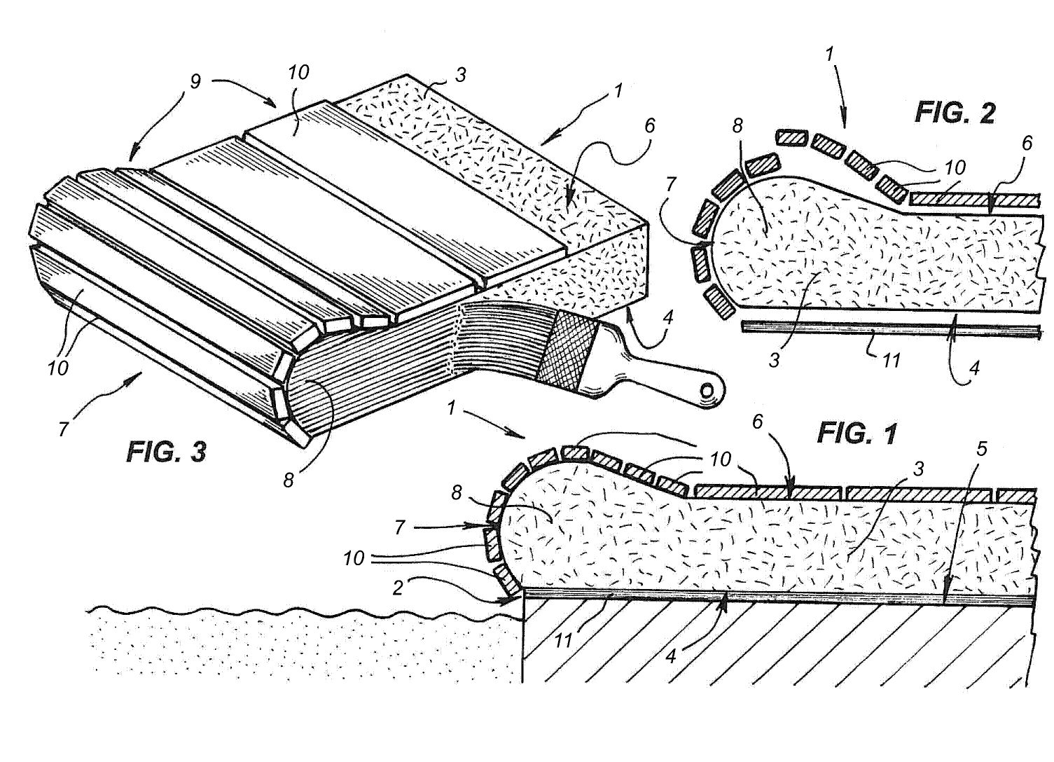

As shown in detail in FIGS. 1 and 2, laying face 4 may be also covered with a protective sheet 11, so that any infiltration and absorption of water into item 1, namely into its core 3, is prevented.

Item 1 is obtained by fixedly applying cover elements 9 to visible face 6 and on side 7 of core 3, e.g. by adhesion bonding using an adhesive material, and by filling the gaps between cover elements 9, known in the art as “joints”, with known filler materials.

Once item 1 has been completed, it may be laid on the surfaces to be covered in a conventional manner, like a normal tile or a cover plate.

The invention was found to fulfill the intended objects.

The invention so conceived is susceptible of a number of changes and variants within the inventive concept.

Furthermore, all the details may be replaced by other technically equivalent parts.

In practice, any materials, shapes and sizes may be used as needed, without departure from the scope of the following claims.

What is claimed is:

1. An item for covering surfaces comprising:
a body, which has a polygonal perimeter defining a visible face faceable outwardly and an opposite lying face, said body comprising:
a bearing core made from a first material having a first specific weight; and
a plurality of covering elements made from a second material having a second specific weight and fixed at least upon said visible face according to a preselected pattern, said first weight being lower than said second specific weight.

2. The item according to claim 1, wherein said covering elements are fixed at least upon said visible face and at least upon one side of said body, which limits at least said visible face.

3. The item according claim 2, wherein said bearing core is a three-dimensional bearing core and comprises said visible face and said one side, said bearing core being shaped according to one or more preselected shaping profiles.

4. The item according to claim 4, wherein said one or more shaping profiles comprise convex or concave profiles.

5. The item according to claim 1, wherein said first material comprises a thermoplastic polymer.

6. The item according to claim 1, wherein said second material comprises a ceramic material, a stone material, a wood material, a plastic material or by-products thereof.

7. An item according to claim 1, wherein said lying face is coupled with a protective laminar element.

8. A method of producing an item for covering surfaces comprising:
providing a bearing core from a first material, said bearing core having a first specific weight and being shaped to define at least a visible face, an opposite lying face, and a perimeter side of said core comprising a frontal side; and
fixing on said visible face and on said perimeter side a plurality of covering elements made from a second material, said second material having a second specific weight higher than said first specific weight, said covering elements being arranged according to a preselected pattern to form a body of the item.

9. The method according to claim 8, wherein said fixing comprises adhesion bonding.

10. The method according to claim 8, further comprising the step of coupling a laminar element of a protective material onto said opposite lying face.
